(19) United States
(12) Patent Application Publication
(10) Pub. No.: US 2009/0158278 A1
(43) Pub. Date: Jun. 18, 2009

(54) System, method, and apparatus for multi-channel user interaction

(76) Inventors: Brent De-Kay, The Woodlands, TX (US); Gil Perez, Los Gatos, CA (US); Yossi Tamari, Ra'anana (IL); Gil Messerman, Holon (IL); Misha Sklarz, Petach Tikva (IL); Amir Sadras, Tel-Aviv (IL)

Correspondence Address: Pearl Cohen Zedek Latzer, LLP, 1500 Broadway, 12th Floor, New York, NY, 10036, US

(21) Appl. No.: 12/000,365

(22) Filed: Dec. 12, 2007

(51) Int. Cl. G06F 9/46

(52) U.S. Cl. 718/100

(57) ABSTRACT

A system and method for receiving a communication from a user over a communication channel, selecting and executing a bot, flow or procedure. The bot, flow or procedure to execute are selected by parameters such as the communication channel used, the device used by the user or a user profile.

### BACKGROUND OF THE INVENTION

Advancements in both communication infrastructures as well as communication devices enable a variety of communication media, each having its own advantages and disadvantages with respect to different users and different purposes. Accordingly, users communicating with an organization, possibly interacting, directly or indirectly, with backend applications, may do so using a variety of devices over a variety of communication channels. Devices used for communication may differ in many ways, for example, processing power, rendering abilities, display size and the like. Furthermore, differing communication channels or infrastructures may enable various communication possibilities. For example, communicating over an internet protocol (IP) network using a computer and/or browser may enable features that may be impossible when communicating with a mobile phone using a wireless network. There is a need for a unified system enabling interactive communication between various communication media or channels and a variety of information services.

### SUMMARY OF EMBODIMENTS OF THE INVENTION

According to some embodiments of the invention, a system, method and/or apparatus may enable users to initiate procedures, retrieve information, or otherwise interact with resources in ways that correspond to the communication channels used for the interaction.

In other embodiments of the invention, interactions may further be in accordance with capabilities and/or parameters pertaining to a device being used for the interaction. In yet other embodiments of the invention interactions may further be in accordance with content received from a user, communication infrastructure used, location of a user, a user profile or time constraints.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIGS. 1A and 1B are a functional block diagrams according to some embodiments of the invention; and

FIG. 2 is a functional block diagram according to some embodiments of the invention;

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

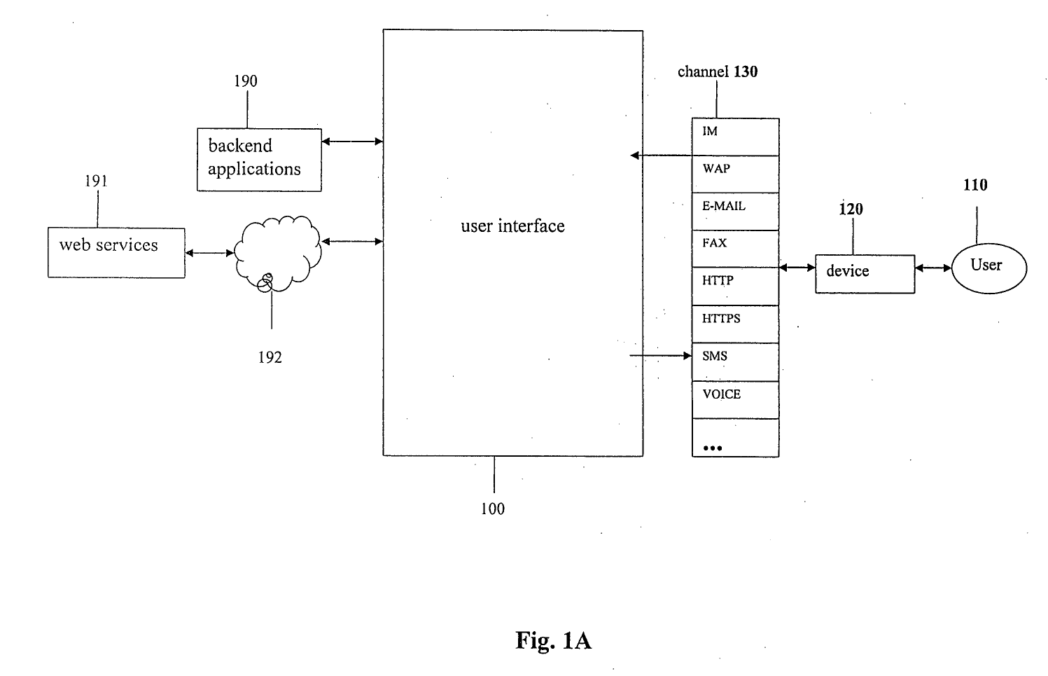

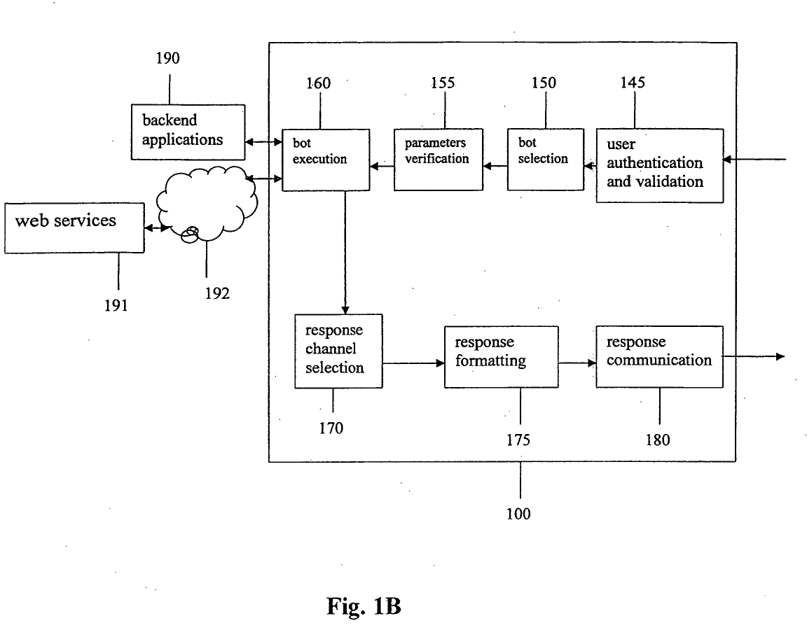

Reference is now made to FIG. 1A, which is a block diagram showing schematic and/or functional elements in accordance with an exemplary embodiment of the invention. According to some embodiments of the invention, user 110 may communicate with user interface system 100, which may be utilized for interfacing, for example, a communication server or information hub of a business organization, an agency, an establishment, an institution, etc. For example, user 110 may be an employee communicating with his or her business organization in order to retrieve and/or store business information; a student connecting to an academic institution to obtain academic information; or medical personnel communicating with a health care facility to obtain test results. According to some embodiments of the invention, user 110 may perform multiple, possibly simultaneous, actions arid/or operations related to user interface system 100. For example, user 110 may be a student retrieving grades from an academic institution as well as submitting forms containing course selections. Such storage and retrieval of information may involve different sub-systems and/or applications comprising user interface system 100.

According to some embodiments of the invention, user 110 may use any one or more of remote input devices 120 for communicating with user interface system 100. For example, user 110 may use a personal digital assistance (PDA), a telephone, a computer, a mobile phone, a pager, a two-way radio, smartphone, communicator, a FAX machine, or other suitable means of communication.

According to some embodiments of the invention, user 110 may use a communication network or infrastructure, in order to communicate with user interface system 100. For example, user 110 may use a wireless communication network, such as Bluetooth, IEEE 802.11x, a public wireless network, wireless local area network (WLAN), IEEE 802.16x (WiMax), satellite communication network, etc., or a terrestrial telephone network, a wired local area network (LAN), wide area network (WAN), or another suitable communication network.

According to some embodiments of the invention, user 110 may use a communication channel 130 for the communication. For example, user 110 may communicate with user interface system 100 using short message service (SMS), instant messaging (IM), wireless application protocol (WAP), electronic mail, dual tone frequency (DTMF) over telephone, a facsimile transmission (FAX), hyper text transfer protocol (HTTP), HTTP over secure socket layer (HTTPS), voice over internet protocol (VOIP), session initiation protocol (SIP) or other suitable input channel and/or protocol.

Based on a communication with user 110, user interface system 100 may interact and/or perform certain operations with one or more backend applications 190. It will be understood that backend applications 190 may include one or more enterprise servers, such as an enterprise resources planning (ERP), a customer relationship management (CRM) system, Web services, and/or other applications or services. Based on the interaction requested by user 110, user interface system 100 may obtain or extract information, invoke procedures, or otherwise interact unilaterally or bilaterally with any one or more backend applications 190. User interface system 100 may further interact and/or perform certain operations with one or more applications, servers and/or web services 191. User interface system 100 may interact with such services over network 192. In some embodiments of the invention, network 192 may be a private network, such as, for example, a private internet protocol (IP) network, or it may be a public network such as the internet.

Reference is made to FIG. 1B, which depicts an embodiment of the present invention including component sub-units and/or functional procedures performed by user interface system 100. It will be understood that some blocks in FIG. 1B may represent separate or unified software procedures, may reside in different hardware components, etc.

According to some embodiments of the invention, the communication from user 110 may be verified and/or authenticated. In some embodiments, information received at system 100 may be verified, for example, prior to further actions which may be performed for, or on behalf of, user 110. Such verification may be performed at block 145 as shown, and may include processes such as, but not limited to, identification of the user, for example, a data storage may be queried at block 145 in order to retrieve a user profile. Further processes at 145 may comprise validation of the user privileges, authentication of the user identity and/or user access rights and or privileges. In some embodiments of the invention, some processes performed at 145 may involve interactions with user 110, for example, user authentication, which may prompt user 110 to provide a password that may be checked against a password stored within system 100 may be performed at block 145. According to some embodiments of the invention, operations and/or procedures performed at block 145 may vary according to channel 130 used. For example, some of the operations performed at block 145 may be performed upon receiving text from a short message service (SMS) channel, or during login when a hyper text transfer protocol (HTML) channel is used.

According to some embodiments of the invention, upon completion of user authentication and/or validation, a bot may be selected at block 150. A bot, as known in the art, is a short name for a robotic computer software entity that may simulate a human or human-style interaction. Some bots typically allow humans to ask questions, for example in plain English, and then formulate proper responses. Bots may be used for handling tasks such as reporting weather, zip-code information, sports scores, converting currency or measurement units, etc. Alternatively, bots may perform complicated tasks such as business transactions, control processes and/or management tasks. In the context of some embodiments of the current invention, a bot may function in the capacity of a process and/or flow manager in addition to its functionality as known in the art. At block 150, for example, after validation of received information, a suitable bot may be selected based on the information requested by user 110. Bot selection block 150 may use a semantic parsing engine to determine the nature of the query or task to be performed, and use a lookup table, possibly stored in a database, to select an appropriate bot. In some embodiments, user 110 may directly or expressly indicate in the communication to system 100 which bot is to be used, in which case, bot selection block 150 may pick out the selection and choose a bot to be used. In the following description of embodiments of the invention, the term bot is used, however, it will be understood that a bot may refer to any software entity or execution module that may perform a given task using input parameters.

According to some embodiments of the invention, the content of information provided by user 110 may be validated at block 155. For example, various queries that may be inquired or information that may be requested by user 110 may require accompanying parameters. Validation and verification block 155 may verify that such required parameters have been provided, and if not, may request them from user 110. Another example may be forms which may be submitted by user 110, which may require certain mandatory fields to be filled, while other forms may require some fields to contain a value selected from a predefined list of values, etc. According to some embodiments of the invention, user 110 may be prompted for additional information at block 155. According to some embodiments of the invention, information validation and/or verification at block 155 may depend on the communication channel used by user 110. For example, if user 110 is using a telephone as the communication channel then the user may be prompted to supply more information by pressing various keys on the telephone keypad in order to complete information required, while in other cases, for example, when user 110 is using short message service (SMS) channel, user 110 may be prompted to provide information in the form of text strings at block 155.

According to some embodiments of the invention, a plurality of bots may be defined within system 100. For example, a bot may be defined for, or associated with, a group of users of system 100. In other embodiments of the invention, a bot may be defined for, or associated with, one or more services provided by applications comprising system 100. For example, a first bot may be defined for, or associated with, a service provided by an enterprise resource planning (ERP) system that may be a part of system 100; a second bot may be defined for, or associated with, a second service provided by the ERP system or a service provided by a customer relationship management (CRM) system of system 100; and a third bot may be defined for, or associated with, a service provided by a proprietary database within system 100. For example, checking stock level of a specific product or group of products may be a service, provided by an ERP system, for which a bot may be defined. According to some embodiments of the invention, bots associated with a service or resources of system 100 may provide an interface to the associated resources or services for use by user 110. Bots defined for, or associated with a resource or service may be defined to alter their functionality according to parameters such as, but not limited to, the communication channel used by user 110, the device used by user 110, time constraints, or location of user 110. In some embodiments of the invention, bots may operate substantially the same irrespective of the communication channel used by user 110, the device used by user 110, time constraints, or location of user 110, and other functional blocks within system 100 may instruct the bot to operate or provide information based on such parameters.

According to some embodiments of the invention, bot selection 150 may depend, at least in part, on a profile associated with user 110, stored, for example, in a database or other suitable storage, such storage or database may be part of system 100 or may be external to system 100. For example, a user profile may be associated with user 110, such profile may contain definitions such as, but not limited to, the interaction language to be used when interacting with system 100, whether or not a help screen will always be available when interacting with system 100, or a list of specific data sources that that will never be searched or queried by bots when operating on behalf of user 110. Such definitions may be stored in a profile of user 110. The user profile may be examined prior to bot selection, and, accordingly, affect bots selection. In other embodiments of the invention, a user profile may be parsed and/or examined by the selected bot or bots, in such cases, definitions contained within a user profile may affect a bot's operation and/or behavior.

According to some embodiments of the invention, bot selection block 150 may depend, at least in part, on the communication channel or channels used by user 110. According to some embodiments of the invention, specific bots, or specific bot's operations, may be defined for, or associated with, specific communication channel 130. For example, a bot providing output communication over a hyper text transfer protocol (HTTP) channel may provide HTTP hyper links in a help screen communicated to user 110 while a bot defined for, or communicating over a short message service (SMS) channel is likely to avoid communicating such information. Another example may be communicating over an instant messaging (IM) channel that may dictate some time constraints on user interaction, for example, time allowed for user to provide some required input. Such time constraints may be eased, or may even be omitted from communication over an email channel. According to some embodiments of the invention, such awareness to the communication channel used may enable bots to provide support for such varying features, constraints and/or other required communication parameters. Bot selection parameters based on communication channel 130 may be stored within system 100.

In some embodiments of the invention, when user interface system 100 is presented with more than one task request for performance, execution of the task requests may be prioritized based on relevant parameters, for example, by input channel of the requests, identity of the users, etc.

In some embodiments of the invention, although bots may be defined for, or associated with, data sources and/or applications of system 100, bots may still be aware of communications aspects such as the communication channel used. For example, a bot defined for, or associated with, a specific data source or application may perform differently when communicating over a WAP channel than when communicating over an electronic mail channel. Such differences may include, for example, operations performed on behalf of user 110, help screens provided to user 110, various filters applied to responses compiled for user 110 and so on.

In some embodiments of the invention, a bot associated with a service may provide output regardless of the communication channel used, in such case, formatting of the response to user 110 may be left to response formatting block 175 as described below, based on the communication channel 130 and/or communication device 120. For example, responses may be provided by a bot in a uniform format, for example, according to extensible markup language (XML).

Response formatting block 175 may transform or convert the output of the selected bot from a uniform format into a format suitable for a particular communication channel 130 and/or device 120. Thus, for example, in some embodiments of the invention, a response formatted in XML may be converted, for example, using extensible stylesheet language (XSL) into a format suitable for a specific channel 130 and/or device 120. In some embodiments, response formatting block may include conversion modules, for example, conversion of text or numerals to voice. Thus, for example, when user 110 communicates with user interaction system 100 using a personal digital assistant (PDA) device, a bot response may be communicated in a text format, while for a user 110 communicating with system 100 using a phone handset, the response formatting block 175 may convert the text or numerical response to an audio format. Other or additional formatting conversion modules may be included in response formatting module 175.

According to some embodiments of the invention, bot selection 150 may depend, at least in part, on location of user 110 or availability or presence of user 110 at a specific location or device. For example, information obtained by means such as, but not limited to, employee management system, global positioning system (GPS), a computerized calendar, usage of an electronic device linked to a network, and/or an activation status of a screen saver on a computer may be used as input to bot selection and/or operation. For example, a bot may communicate responses to a user computer possibly in addition to the device used by user 110 based on the information that user 110 is present at his or her computer. Another example may be bot selection and/or operation according to a connection, or an operational mode, for example, user 110 connecting from home may be considered a first connection mode while user 110 connected from within system 100, possibly over an internal local area network (LAN) may be considered a second, different connection mode. For example, responses or results that contain confidential information that may be communicated to a device associated with user 110 only if the device is directly connected to an internal, possibly secured, network. Time constraints may be another example, for example, in a stock market related business where certain hours, days of the week or dates of the month may dictate various rules pertaining to system 100 resources usage, such rules may in turn affect bot selection 150 and/or bot execution 160.

According to some embodiments of the invention, bot selection 150 and/or bot execution 160 may depend, at least in part, on information provided by user 110. For example, a specific bot may be defined for specific user requests. In other cases, a bot may be associated with specific backend applications 190 and/or servers in system 100, such applications may need to be invoked based on information provided by user 110. According to some embodiments of the invention, user 110 may provide specific bot selection parameters that may be used, possibly in conjunction with other parameters, for bots selection and/or operation. For example, user 110 may function as both a product manager as well as a system engineer. In some embodiments of the invention, a first bot selection list may be presented to user 110 when user 110 communicates with system 100 in the capacity of a product manager while a second, different, bot selection list may be presented to user 110 when communicating with system 100 in the capacity of a system engineer. Different bots may operate differently, provide different interfaces, menus, database queries and response formats.

According to some embodiments of the invention, user 110 may choose which bot to operate in a verity of ways. For example, user 110 may be offered a list of bots to choose from, or user 110 may provide the preferred bot as part of the information provided upon connection. In other embodiments of the invention, a bot may be selected by system 100, possibly based on various parameters such as those described earlier, e.g. data sources involved, queries made by user 110, communication device used by user 110, communication channel., user identification and/or user profile etc. According to some embodiments of the invention, failure to select a bot may result in a communication of a help message to user 110 (not shown), possibly instructing and/or aiding user 110 to select a bot, as well as possibly, helping user 110 to provide required parameters.

According to some embodiments of the invention, a bot or bots selected may be executed as shown by block 160. A bot execution may comprise interacting with backend applications 190 and/or interacting with applications or services outside system 100, such as, for example, servers and/or applications 191 that may be interacted over network 192. For example a bot may interact with an internal database of system 100, or a CRM system within system 100 as well as invoke services such as web services. Such web services may be provided by web servers outside system 100. A bot's execution may comprise interactions with applications and services, for example, database queries and/or service invocation, as well as processing of data, for example, validation and manipulation of data retrieved from various sources.

According to some embodiments of the invention, the channel over which to communicate the responses to user 110 may be selected as shown by block 170. According to some embodiments of the invention, responses may be communicated over the same channel used by user 110 for contacting system 100. In other cases or embodiments, a communication channel and/or a destination device may be selected for the responses according to various parameters. For example, sensitive data may be returned to a user 110 over one of selected secured channels, for example, which may not be the channel used for the input communication. As another example, user 110 may contact system 100 by fax, but may request to have responses communicated to his or her secured email account. In other cases or scenarios, user 110 may contact system 100 using a mobile phone, yet have responses communicated over an HTTP channel, enabling hyper links and extended graphics to be incorporated into the responses. According to some embodiments of the invention, the communication channel over which responses are returned to user 110 may be explicitly selected by user 110.

According to some embodiments of the invention, at block 175, output information of procedures performed for, or on behalf of, user 1 10 may be formatted, converted and/or transformed according to various parameters.

According to some embodiments of the invention, manipulations of data at block 175 may depend on the relevant bot. For example, a bot definition may comprise data formatting, transforming and/or conversion definitions that may be performed. Exemplary transformations of data at 175 may be extensible stylesheet language (XSL) transformations. XSL transformations may convert input data, formatted according to, or as extensible markup language (XML), into other readable documents, possibly formatted as XML documents, text documents, hypertext markup language (HTML) documents or other formats. XSL transformation may convert data types into other types, replace fields values by other values and so on. According to some embodiments of the invention, manipulations of data may further comprise java code based manipulation. Such manipulation may generally comprise any modifications possible by software. According to some embodiments of the invention, manipulations of data at 175 may further comprise template based manipulation of the data received as input to the data output module. Such templates, possibly defined by an administrator of system 100, may define various operations that may be performed on the input data.

According to some embodiments of the invention, manipulations of data at 175 may be defined by a privileged user and/or administrator of system 100 as part of a bot definition. In other embodiments of the invention, manipulations of data at 175 may depend on the communication channel used by user 110 for the interaction with system 100. In yet other embodiments of the invention, manipulations of data at 175 may depend on the communication device used by user 110, or location of user 110. In yet other embodiments of the invention, manipulations of data at 175 may be performed according to a user profile associated with user 110, for example, user 110 may prefer to receive results according to a specific format, for example, with no pictures.

According to some embodiments of the invention, manipulations and/or formatting of responses at 175 may be performed in accordance with the communication channel selected for communicating the responses to user 110.

According to some embodiments of the invention, templates, java applications and/or XSL documents which may be invoked at 175 may be accessed via plugins. In such configuration, templates, java applications and XSL documents may be stored on any suitable storage devices within system 100. When a new template, java applications or an XSL definition document are added, a corresponding plugin is added to the list of plugins accessible by bots, consequently enabling invocation by bots as, or when, required.

According to some embodiments of the invention, a response may be communicated to user 110 at block 180. A response may comprise information which was retrieved, manipulated and formatted as described. A response may further comprise an error indication, for example when a bot fails to execute some of the tasks related to the information, or queries, provided by user 110, alternatively, a response may comprise a success indication.

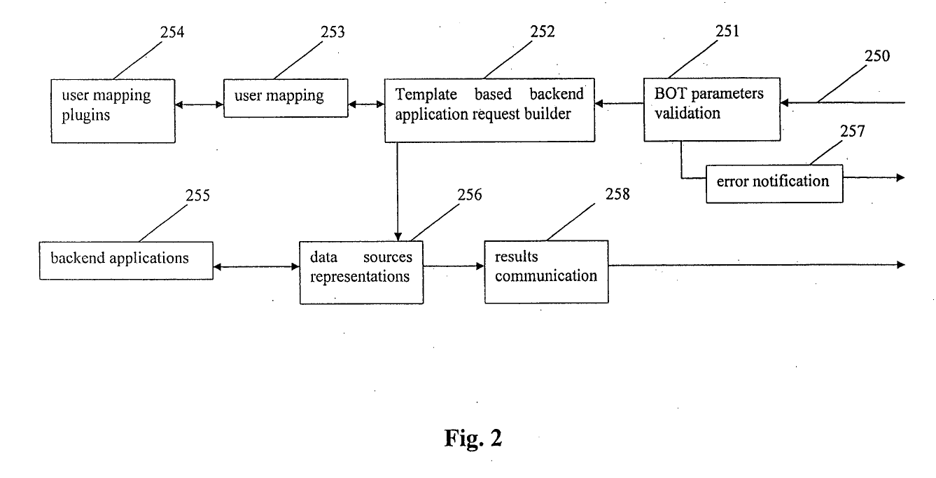

Reference is now made to FIG. 2, which is a block diagram showing schematic and/or functional elements of a bot execution in accordance with an exemplary embodiment of the invention. According to some embodiments of the invention, input information and/or parameters may be provided to an execution of a bot as shown by arrow 250. According to some embodiments of the invention, input information and/or parameters required for the execution of a bot may be validated at block 251. Such parameters may be, for example, parameters provided by user 110, and/or from the communication channel 130 used by user 110, as well as other aspects of the interaction, such as device 120 used by user 110. Other parameters may be provided by processes such as user and/or input validation 145, for example, user privileges and/or credentials may be used as input parameters for a bot execution. According to some embodiments of the invention, if such validation block 160 fails, then a notification of the failure may be communicated to user 110 as shown by 257. Such notification may suggest possible actions, for example, an indication of the information missing by the selected bot may be provided to user 110. Since a specific bot may already be selected at this point, specific usage guidance for the selected bot may also be provided to user 110 at block 257.

In some embodiments of the invention, a user mapping may be employed in order to obtain correct and/or required representation of user 110. For example, the name of user 110 may be John Doe, but the back-end application that may be needed to be invoked during bot execution may require a middle name user 110. User mapping plugins (254) may be used by user mapping block (253) in order to retrieve such information, for example, from storage, database or other applications. For example, a lightweight directory access protocol (LDAP) and/or any other suitable application may be used for such purposes. A user mapping may use one or more user mapping plugins (254) in order to communicate with such applications. Request builder (252) may use required information, such user information retrieved by user mapping 253 in order to compile requests, queries and/or other interactions with applications such as, but not limited to, backend applications and/or web services that may be internal to system 100 or external.

According to some embodiments of the invention, simple object access protocol (SOAP) requests may be used by block 252 in order to access services either within system 100 or, in some cases, outside system 100. According to some embodiments of the invention, data sources representations block 256 may provide request builder block 252 with proper and/or necessary interface to backend applications or external services. According to some embodiments of the invention, block 252 may provide data sources representations 256 with complete, properly formatted and rendered simple object access protocol SOAP envelops, data sources representations 256 may generate appropriate requests to the appropriate application or service providing entity. For example, data sources representations 256 may generate a hyper text transfer protocol (HTTP) request based on a SOAP envelope provided by block 252. According to some embodiments of the invention, block 252 may use information retrieved from, or provided by, blocks 251 and/or 253 in order to compile such SOAP envelopes.

According to some embodiments of the invention, data sources representations block 256 may transform a unified representation of service requests, for example SOAP requests, into specific requests or interactions, such as, but not limited to, procedure calls, remote procedure calls, requests, queries, web services description language (WSDL) requests, hyper text transfer protocol (HTTP) request or any other suitable proprietary operations as may be dictated by the service providing entity, such as backend applications 255 or an external service providing entity (not shown).

According to some embodiments of the invention, using a standard representation such as SOAP for defining service request templates may enable an operator or administrator of system 100 to easily define templates of interactions with backend, or other applications. Such templates may then be dynamically selected by a bot at run time. A template may contain one or more fields that may be filled by request builder block 252 before being passed on to block 256 for execution. Such fields may be names, quantities, dates and the like. According to embodiments of the invention, results from interactions with backend applications, web services, and/or other services or applications, may be provided to other modules or entities as shown by block 258. For example, results may be provided, directly or indirectly, to a response channel selection block or a response formatting block as shown in FIG. 1.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
receiving a task request over one of a plurality of input communication channels;
selecting based on said task request at least one execution module from a plurality of execution modules;
executing said selected execution module to perform a task associated with said task request;
formatting a response for transmission over one of a plurality of output communication channels, said response based on an output of the execution of said selected execution module; and
transmitting said formatted response over said one output communication channel.

2. The method of claim 1, further comprising identifying a user based on a parameter provided over said input communication channel.

3. The method of claim 1 further comprising:
receiving first and second task requests over first and second input communication channels, respectively;
selecting based on said first and second task requests first and second execution modules from said plurality of execution modules;
executing said first and second selected execution modules to perform tasks associated with said first and second task requests,
wherein executing said first and second selected execution modules comprises prioritizing said first and second task requests.

4. The method of claim 1 wherein said execution module selection is based, at least in part, on at least one indicator of a location of said user.

5. The method of claim 1 further comprising selecting said output channel from said plurality of output channels.

6. The method of claim 1 wherein executing said execution module is based, at least in part, on a user profile.

7. The method of claim 1 wherein executing said execution module is based, at least in part, on a time constraint.

8. The method of claim 1 wherein executing said execution module is based, at least in part, on at least one indicator of a location of said user.

9. The method of claim 1 wherein said communication channels are selected from the group consisting of wireless application protocol (WAP) channel, an audio channel, instant messaging (IM) channel, short message service (SMS) channel, electronic mail channel, telephone network channel, internet protocol (IP) network channel, internet channel, a wireless network channel, bluetooth network channel, an hyper text transfer protocol (HTTP) channel, a hypertext transfer protocol over secure socket layer (HTTPS) channel, a two-way radio channel, a pager channel, and facsimile transmission system (FAX) channel.

10. The method of claim 9 wherein formatting said response for transmission comprises converting said output of the execution of said selected execution module into a format determined based at least in part, on a type of device used by said user.

11. The method of claim 9 wherein formatting said response for transmission comprises converting said output of the execution of said selected execution module into a format determined based at least in part, on said output channel.

12. The method of claim 1 wherein formatting said response for transmission comprises transforming said output of the execution of said selected execution module from a first format into a second format, wherein said transformation is selected from the group consisting of an extensible stylesheet language (XSL) transformation, a java code based transformation, and a template based transformation.

13. The method of claim 1, wherein said execution module execution is independent of said input communication channel.

14. The method of claim 1 wherein said execution module selection is based, at least in part, on at least one indicator of a presence of said user at a predefined location

15. The method of claim 1 wherein said execution module selection is based, at least in part, on at least one indicator of a connection mode of said user.

16. The method of claim 1 wherein said execution module selection is based, at least in part, on at least one indicator of a state of a communication device used by said user.

17. A system comprising:
a plurality of execution modules, each adapted to perform at least one task;
an input module for receiving a task request over one of a plurality of input communication channels;
a selection module for selecting based on said task request at least one execution module from said plurality of execution modules;
a formatting module for formatting a response for transmission over one of a plurality of output communication channels, said response based on an output of the execution of said selected execution module; and
an output module for transmitting said formatted response over said one output communication channel.

18. The system of claim 17 further comprising a locator module for providing a location of said user, wherein said selection module selects said execution module based, at least in part, on said location.

19. The system of claim 17, further comprising an output channel selection module for selecting said output channel from said plurality of output channels.

20. The system of claim 17, further comprising a repository of user profiles, wherein executing said execution module is based, at least in part, on a user profile associated with said task request.

21. The system of claim 17 further comprising a plurality of communication channels, wherein said communication channels are selected from the group consisting of wireless application protocol (WAP) channel, an audio channel, instant messaging (IM) channel, short message service (SMS) channel, electronic mail channel, telephone network channel, internet protocol (IP) network channel, internet channel, a wireless network channel, bluetooth network channel, an hyper text transfer protocol (HTTP) channel, a hypertext transfer protocol over secure socket layer (HTTPS) channel, a two-way radio channel, a pager channel, and facsimile transmission system (FAX) channel.

22. The system of claim 17, further comprising a conversion module for converting said output of the execution of said selected execution module into a format determined based at least in part, on a type of device used by said user.

23. The system of claim 22, wherein said conversion module is a transformation selected from the group consisting of an extensible stylesheet language (XSL) transformation, a java code based transformation, and a template based transformation.
